(19) United States
(12) Patent Application Publication
(10) Pub. No.: US 2026/0281264 A1
(43) Pub. Date: Sep. 17, 2026

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventors: Yoshihiro SEKINE, Kanagawa (JP); Tomohiro MIZUNO, Kanagawa (JP); Yui HIROYA, Kanagawa (JP); Yoshihide SAKAI, Kanagawa (JP); Yuki MINAMISAKO, Kanagawa (JP); Aohan CHEN, Kanagawa (JP)

(73) Assignee: FUJIFILM Business Innovation Corp., Tokyo (JP)

(21) Appl. No.: 19/331,465

(22) Filed: Sep. 17, 2025

(30) Foreign Application Priority Data
Mar. 17, 2025 (JP) 2025-042172

(51) Int. Cl. H04N 1/00

(52) U.S. Cl. CPC H04N 1/00514; H04N 1/00424; H04N 2201/0094

(57) ABSTRACT

An information processing system includes a processor configured to: in a case where an operation screen of a user has been changed from a default setting state and a new operator to be added on the operation screen occurs, when or after the user logs in, notify the user that there is a new operator to be positioned on the operation screen; and position the new operator in a region of the operation screen selected by the user.

### CROSS-REFERENCE TO RELATED APPLICATIONS

This application is based on and claims priority under 35 USC 119 from Japanese Patent Application No. 2025-042172 filed March 17, 2025.

### BACKGROUND

### Technical Field

The present disclosure relates to an information processing system and a non-transitory computer readable medium.

### Related Art

In Japanese Unexamined Patent Application Publication No. 2013-003625, a screen update method for, in registration of an icon of an installed application on a home screen, changing, depending on whether or not the home screen is customized, a processing method for registering the icon on the home screen, is disclosed.

In Japanese Unexamined Patent Application Publication No. 2013-246744, a service system in which a mobile communication terminal is used for a service is disclosed. The service system manages an application and a file that are able to be used by each user and downloads an application that is able to be used by the user if the application does not reside on a mobile communication terminal.

In Japanese Unexamined Patent Application Publication No. 2019-049773, an information processing apparatus that manages user information of a user who has installed an application and a user who frequently uses the application in association with the application and highlights an icon of an application that is associated with user information containing a logged-in user, is disclosed.

### SUMMARY

In the case where an information processing apparatus such as an image forming apparatus is shared among a plurality of users, a layout of operators such as operation buttons on an operation screen may be changed from a default setting state and customized for individual users. Under these circumstances, even in the case where a user has customized an operation screen of the user, if an operator is added by a different user such as an administrator, the layout that has been changed to fit the user’s preference is destroyed.

Aspects of non-limiting embodiments of the present disclosure relate to providing an information processing system and a non-transitory computer readable medium capable of, in a case where a user has changed a layout of operators on an operation screen from a default setting state and uses the changed layout, preventing a new operator from being added on the operation screen against intention of the user.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: in a case where an operation screen of a user has been changed from a default setting state and a new operator to be added on the operation screen occurs, when or after the user logs in, notify the user that there is a new operator to be positioned on the operation screen; and position the new operator in a region of the operation screen selected by the user.

### BRIEF DESCRIPTION OF THE DRAWINGS

Exemplary embodiments of the present disclosure will be described in detail based on the following figures, wherein:

FIG. 1 is a diagram illustrating a system configuration of an information processing system according to an exemplary embodiment of the present disclosure;

FIG. 2 is a diagram illustrating the state in which a user has logged into one of a plurality of image forming apparatuses;

FIG. 3 is a block diagram illustrating a hardware configuration of an image forming apparatus according to an exemplary embodiment of the present disclosure;

FIG. 4 is a block diagram illustrating a functional configuration of an image forming apparatus according to an exemplary embodiment of the present disclosure;

FIG. 5 is a diagram illustrating an example of a home screen displayed on an operation panel of the image forming apparatus;

FIG. 6 is a diagram illustrating an example of a customize mode screen displayed when a customize mode is entered;

FIG. 7 is a diagram illustrating an example of a home screen after customization is performed;

FIG. 8 is a flowchart for explaining a process for displaying a home screen on the operation panel of the image forming apparatus;

FIG. 9 is a diagram illustrating a first example of a notification screen for notifying that there is a new operation button to be positioned on a home screen;

FIG. 10 is a diagram illustrating an example of an operation screen for adding an icon;

FIG. 11 is a diagram illustrating an example of an operation screen for adding an icon;

FIG. 12 is a diagram illustrating an example of a home screen after an application icon is added;

FIG. 13 is a diagram illustrating a second example of a notification screen for notifying that there is a new operation button to be positioned on a home screen;

FIG. 14 is a diagram illustrating a third example of a notification screen for notifying that there is a new operation button to be positioned on a home screen;

FIGS. 15A and 15B are diagrams illustrating a fourth example of a notification screen for notifying that there is a new operation button to be positioned on a home screen;

FIGS. 16A and 16B are diagrams illustrating a fifth example of a notification screen for notifying that there is a new operation button to be positioned on a home screen;

FIG. 17 is a diagram illustrating a sixth example of a notification screen for notifying that there is a new operation button to be positioned on a home screen;

FIG. 18 is a diagram illustrating a seventh example of a notification screen for notifying that there is a new operation button to be positioned on a home screen;

FIG. 19 is a flowchart for explaining a process for the case where, when a new operation button to be added is not able to be used on the apparatus, a notification indicating that there is a new operation button to be positioned on a home screen is not provided; and

FIG. 20 is a diagram for explaining a case where a user sets individual layout data that is common among a plurality of image forming apparatuses and individual layout data for a specific type of apparatus for a specific image forming apparatus.

### DETAILED DESCRIPTION

Next, exemplary embodiments of the present disclosure will be described in detail with reference to drawings.

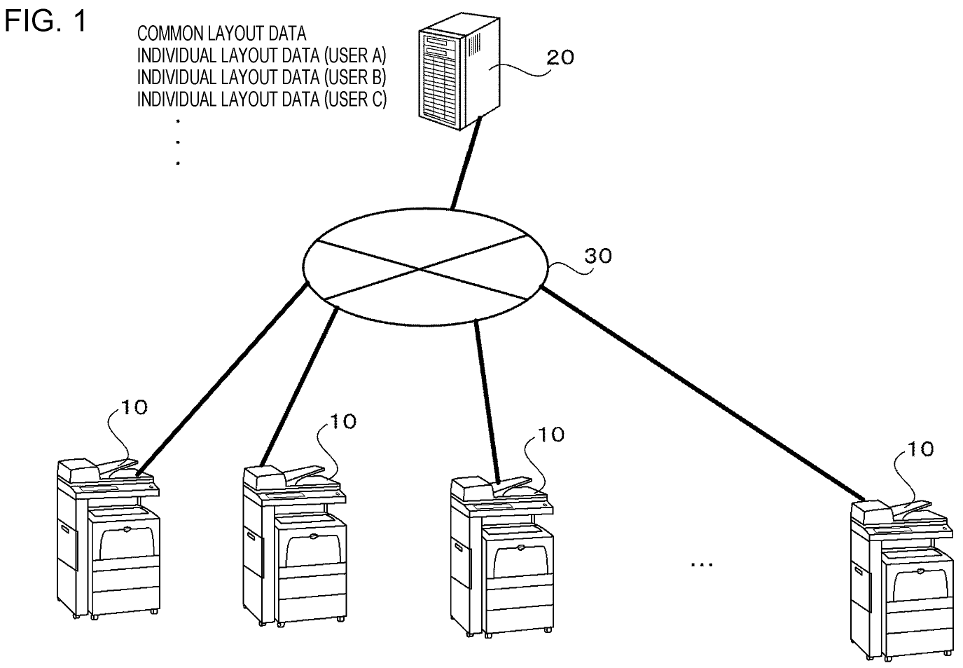

FIG. 1 is a diagram illustrating a system configuration of an information processing system according to an exemplary embodiment of the present disclosure.

An information processing system according to an exemplary embodiment of the present disclosure includes, as illustrated in FIG. 1, a plurality of image forming apparatuses 10 and a management server 20. Each of the image forming apparatuses 10 is connected to the management server 20 via the Internet 30. The image forming apparatus 10 is a so-called multifunction machine provided with multiple functions including a print function, a scan function, a copy function, a facsimile function, and the like.

In each of the plurality of image forming apparatuses 10 according to this exemplary embodiment, a layout of operation buttons positioned on a home screen that is first displayed on an operation panel when a user logs in is able to be customized for the user. A home screen customized by a user is able to be used in common among the plurality of image forming apparatuses 10. For example, in the case where a user A customizes a layout of icons such as operation buttons on a home screen, the layout of the operation buttons on the home screen customized by the user A is created as individual layout data. Then, the individual layout data is stored into the management server 20. As illustrated in FIG. 1, common layout data, which is a layout of operation buttons in a default setting state, and individual layout data for individual users are stored in the management server 20.

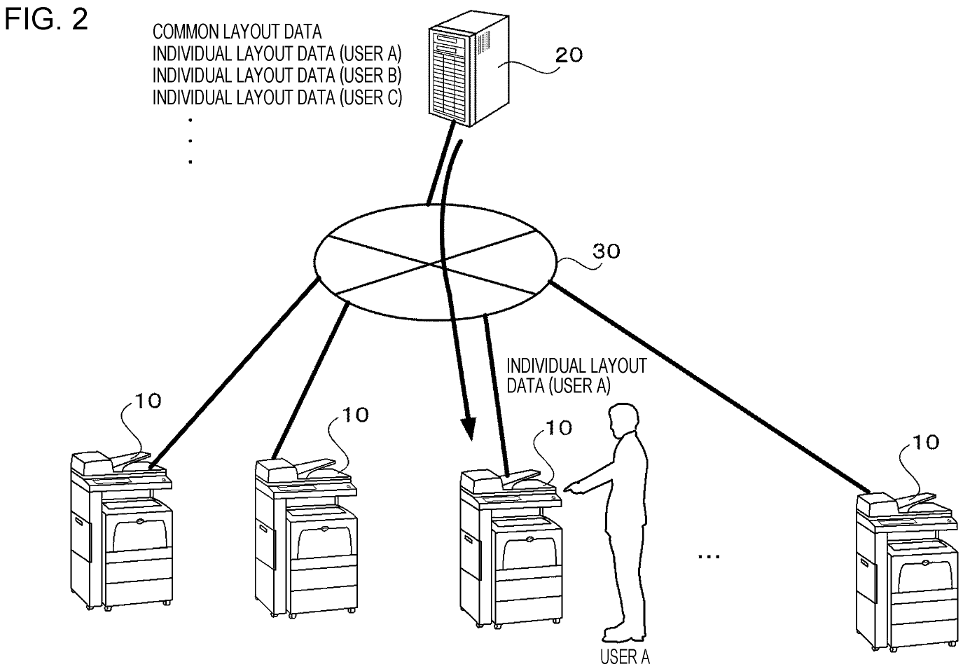

The state in which the user A has logged into an image forming apparatus 10 among the plurality of image forming apparatuses 10 is illustrated in FIG. 2. As illustrated in FIG. 2, when the user A is authenticated for one of the pluralities of image forming apparatuses 10 and logs into the image forming apparatus 10, individual layout data of the user A is downloaded from the management server 20 onto the image forming apparatus 10 the user A has logged in. Then, on the image forming apparatus 10, a home screen based on the downloaded individual layout data is displayed for the user A. For a user who has not changed the default setting state to customize a home screen, a home screen based on the common layout data is displayed.

An operation button positioned as an icon on a home screen is a type of an operator. An icon is a design image displayed on an operation screen and provided to start a specific application program (hereinafter, referred to as an application) and indicate an operation position for transitioning to a specific screen. A design image is not necessarily a designed figure and may include various characters such as alphabets, hiragana, katakana, and kanji.

In the case where an image forming apparatus 10 is installed in, for example, a company, an administrative user (hereinafter, simply referred to as an administrator) who takes charge of management of the image forming apparatus 10 may be appointed from among users. The administrator is granted wide operation authority compared to general users and is able to perform operations that the general users are not allowed to perform. For example, the administrator is able to install a new application onto the image forming apparatus 10 and add an operation button for starting the application on home screens of all the users. However, in the case where a user has customized a layout of operation buttons on a home screen of the user, if an operation button is added by a different user such as an administrator, the layout that has been changed to fit the user’s preference is destroyed.

Thus, in an information processing system according to an exemplary embodiment, by performing a process explained below, in the case where a user has changed a layout of operation buttons on an operation screen such as a home screen from a default setting state and uses the changed layout, a new operator is prevented from being added on the operation screen against intention of the user.

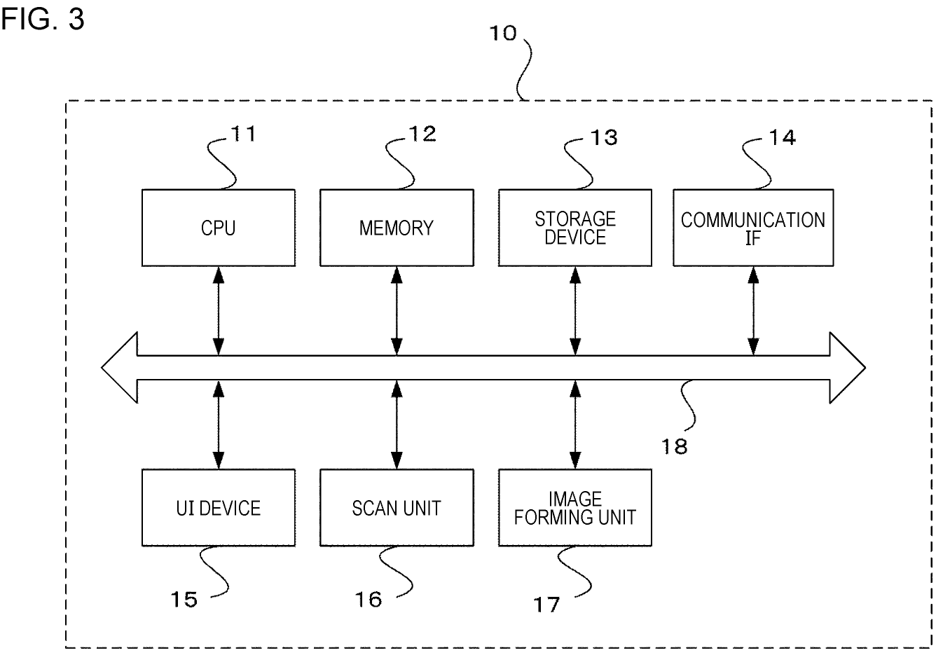

Next, a hardware configuration of the image forming apparatus 10 in an image forming system according to an exemplary embodiment is illustrated in FIG. 3.

The image forming apparatus 10 includes, as illustrated in FIG. 3, a central processing unit (CPU) 11, a memory 12, a storage device 13 such as a hard disk drive, a communication interface (IF) 14 that performs transmission and reception of data to and from, for example, an external apparatus, via the Internet 30, a user interface (UI) device 15 including a touch panel or a liquid crystal display and a keyboard, a scan unit 16, and an image forming unit 17. These component elements are connected by a control bus 18.

The image forming unit 17 performs processes including charging, exposure, developing, transfer, fixing, and the like to print an image on a recording medium such as printing paper.

The CPU 11 is a processor that performs a predetermined process based on a control program stored in the memory 12 or the storage device 13 and controls operation of the image forming apparatus 10. As described above, in this exemplary embodiment, the CPU 11 reads and executes the control program stored in the memory 12 or the storage device 13. However, the CPU 11 does not necessarily read and execute the control program stored in the memory 12 or the storage device 13. The control program may be recorded in a computer-readable recording medium and supplied. For example, the control program may be recorded in an optical disc such as a compact disc-read only memory (CD-ROM) or a digital versatile disc-read only memory (DVD-ROM) or in a semiconductor memory such as a universal serial bus (USB) memory or a memory card and supplied. Furthermore, the control program may be acquired from an external apparatus via a communication line connected to the communication interface 14. Moreover, the control program may be supplied as, for example, a single piece of application software or may be integrated as a function of the image forming apparatus 10 into software of the apparatus.

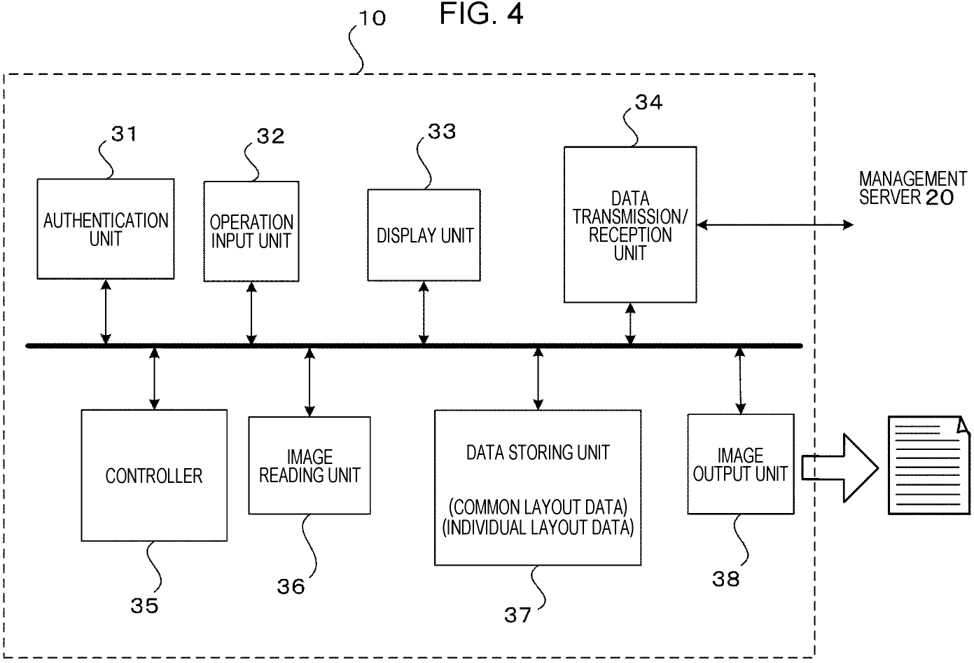

FIG. 4 is a block diagram illustrating a functional configuration of the image forming apparatus 10 implemented when the control program mentioned above is executed.

The image forming apparatus 10 according to this exemplary embodiment includes, as illustrated in FIG. 4, an authentication unit 31, an operation input unit 32, a display unit 33, a data transmission/reception unit 34, a controller 35, an image reading unit 36, a data storing unit 37, and an image output unit 38.

The display unit 33, under the control of the controller 35, displays various types of information for a user. The operation input unit 32 receives various types of operation information input by a user. The data transmission/reception unit 34 performs transmission and reception of data to and from an external apparatus such as the management server 20.

The controller 35 causes the data transmission/reception unit 34 to receive common layout data or individual layout data for each user from the management server 20 and causes the data storing unit 37 to store the received common layout data or individual layout data. The controller 35 also performs control for generating print data based on a job received through the data transmission/reception unit 34 from an external apparatus and causing the image output unit 38 to output the generated print data. The data storing unit 37 stores various data including the common layout data, the individual layout data, the print data generated by the controller 35, and the like.

The image output unit 38, under the control of the controller 35, outputs an image onto a recording medium such as printing paper. The image reading unit 36, under the control of the controller 35, reads a document image from a set document.

Then, the controller 35 displays on the display unit 33 a home screen based on the common layout data or the individual layout data stored in the data storing unit 37.

Furthermore, in the case where a home screen that is an operation screen of a user has been changed from a default setting state and an operation button as a new operator to be added on the home screen occurs, when or after the user logs in, the controller 35 notifies the user that there is a new operation button to be positioned on the home screen. Then, the controller 35 positions the new operation button in a region of the home screen selected by the user.

A new operation button to be added on a home screen is an operation button that has been made to be added as a result of an operation by a different user who is not the logged-in user. For example, the different user who is not the logged-in user is an administrative user, and a new operation button to be added on a home screen is an operation button added by the administrative user or an operation button for operating an application installed by the administrative user.

Furthermore, in the case where a home screen of a user has been changed from a default setting state and a new operation button to be added on the home screen occurs, when or after the user logs in, the controller 35 displays on the home screen a display operation button for notifying that there is a new operation button to be positioned on the home screen and displaying the operation button that has not been positioned. Then, in response to an operation on the display operation button by the user, the controller 35 displays the operation button that has not been positioned.

The controller 35 may display the display operation button in a region of the home screen in which a new operation button is able to be positioned. Alternatively, in a state in which a customize screen, which is a change mode screen for changing the layout of operation buttons, is entered, the controller 35 may display the display operation button on the home screen.

Furthermore, the controller 35 may continue to notify that there is a new operation button to be positioned on the home screen until all the new operation buttons to be added have been positioned on the home screen.

In the information processing system according to the exemplary embodiment illustrated in FIG. 1, all the image forming apparatuses 10 have the same function and same configuration. However, in the information processing system including a plurality of image forming apparatuses, the plurality of image forming apparatuses may have different functions. For example, there may be a case where an image forming apparatus does not have a facsimile function and another image forming apparatus does not have a scanner function. In such a case, even when a new application is installed into an image forming apparatus by the administrator, if the image forming apparatus is not provided with a function corresponding to the application, there is no need to position an operation button for starting the application on a home screen.

To deal with such a case, a condition for a new operation button that requires notification when being added is stored in advance in the data storing unit 37. In the case where a home screen of a user has been changed from a default setting state and a new operation button to be added on the home screen occurs, the controller 35 determines whether or not the operation button satisfies the condition stored in the data storing unit 37. In the case where the operation button satisfies the condition stored in the data storing unit 37, when or after the user logs in, the controller 35 notifies the user that there is a new operation button to be positioned on the home screen. Then, the controller 35 positions a new operator in a region of the home screen selected by the user. Even in the case where a new operation button to be added on the home screen occurs, if the operation button does not satisfy the condition mentioned above, when or after the user logs in, the controller 35 does not notify the user that there is a new operator to be positioned on the operation screen.

Next, an operation of the image forming apparatus 10 in the information processing system according to this exemplary embodiment will be described in detail with reference to drawings.

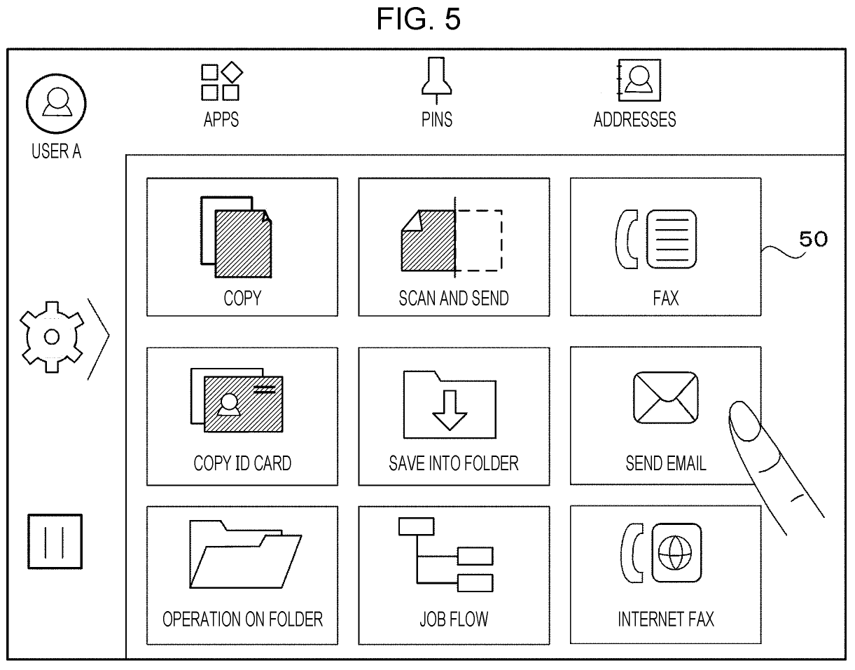

An example of a home screen displayed on the operation panel of the image forming apparatus 10 is illustrated in FIG. 5. FIG. 5 illustrates the state in which a plurality of operation buttons 50 are positioned on the home screen. By selecting and operating any one of the plurality of operation buttons 50, the user is able to start a specific application and perform an operation on the image forming apparatus 10. In the example of the home screen illustrated in FIG. 5, a layout in a default setting state is illustrated.

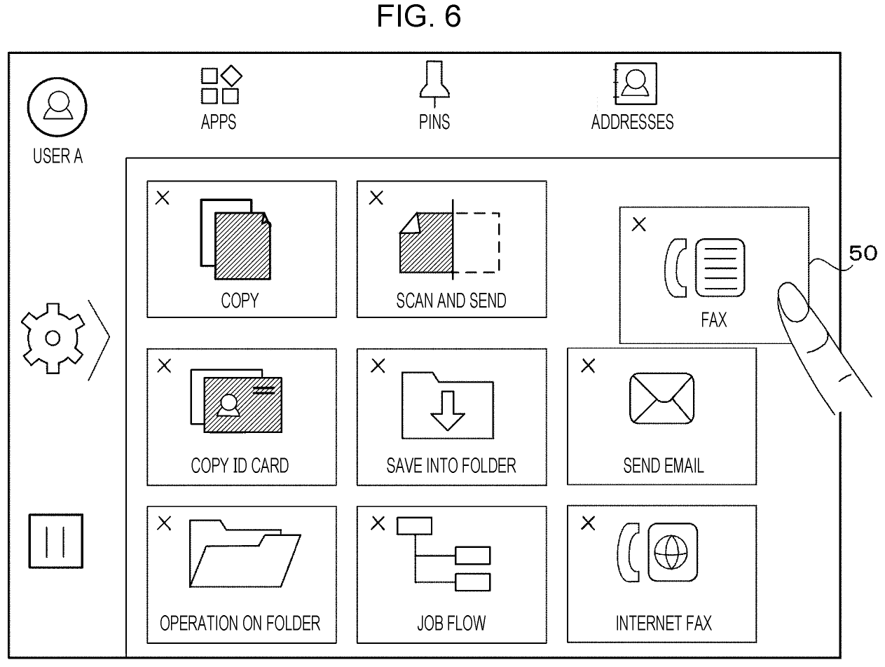

In the example of the home screen illustrated in FIG. 5, in the case where the user has pressed and held on the screen for a certain period of time or more, the operation mode is transitioned from a normal mode to a customize mode. The customize mode is an operation mode for changing the arrangement of the operation buttons 50 on the home screen to fit the preference of the user. An example of a customize mode screen displayed when the operation mode is transitioned to the customize mode is illustrated in FIG. 6.

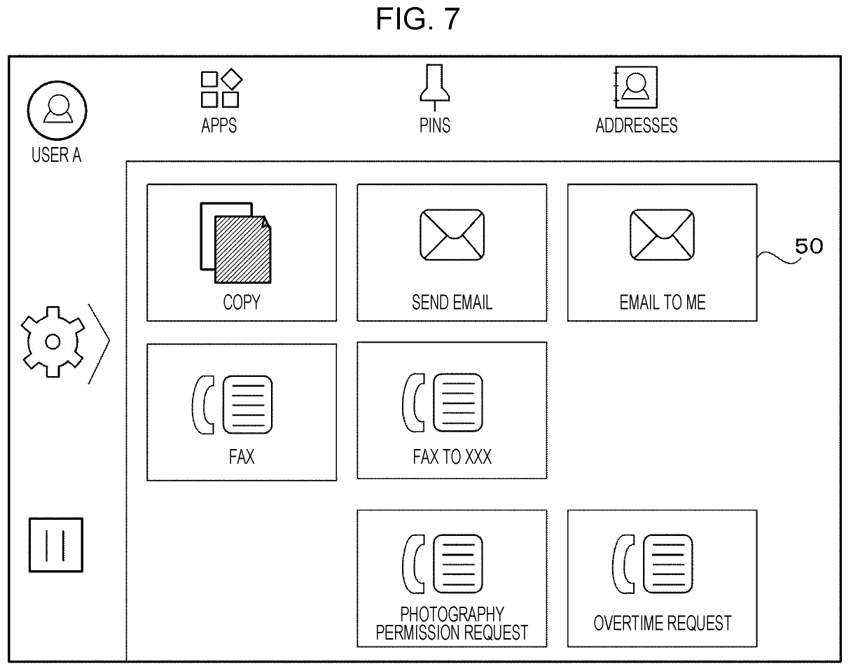

On the customize mode screen illustrated in FIG. 6, the user is able to change the arrangement of the operation buttons 50 or exchange the locations of the operation buttons 50 by a drag operation. An example of a home screen after the user A changes the arrangement of the operation buttons 50 from the default setting state to perform customization in the customize mode is illustrated in FIG. 7.

As is clear from the home screen after customization illustrated in FIG. 7, the arrangement of the operation buttons 50 has been changed from the home screen in the default setting state. Furthermore, operation buttons 50 generated by the user are positioned on the home screen after customization illustrated in FIG. 7.

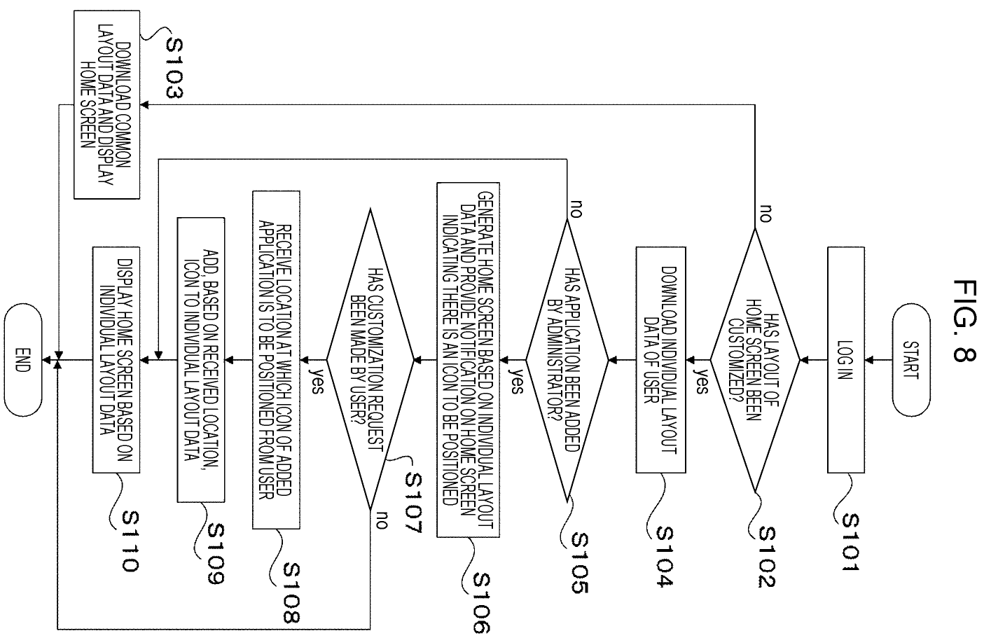

Next, a process for displaying a home screen on the operation panel of the image forming apparatus 10 will be described with reference to a flowchart in FIG. 8.

First, in the image forming apparatus 10, the controller 35 receives a log-in operation by a user in step S101. In step S102, the controller 35 determines whether or not the layout of a home screen of the logged-in user has been customized. Specifically, the controller 35 determines, by accessing the management server 20 via the Internet 30 to check whether or not individual layout data of the logged-in user is stored in the management server 20, whether or not the logged-in user has customized the home screen.

In the case where it is determined in step S102 that the logged-in user has not customized the home screen, the controller 35 downloads common layout data from the management server 20 and displays a corresponding home screen on the operation panel in step S103. In this case, the home screen in the default setting state is displayed on the operation panel.

In the case where it is determined in step S102 that the logged-in user has customized the home screen, the controller 35 downloads the individual layout data of the user from the management server 20 in step S104.

In step S105, the controller 35 determines whether or not, for example, an application, has been added by the administrator. That is, the controller 35 determines whether or not there is a new operation button to be added on the home screen.

In the case where it is determined in step S105 that, for example, an application, has not been added by the administrator, the controller 35 displays the home screen based on the downloaded individual layout data on the operation panel in step S110.

In the case where it is determined in step S105 that, for example, an application, has been added by the administrator, the controller 35 displays the home screen based on the individual layout data on the operation panel and notifies the user that there is a new operation button to be positioned on the home screen in step S106.

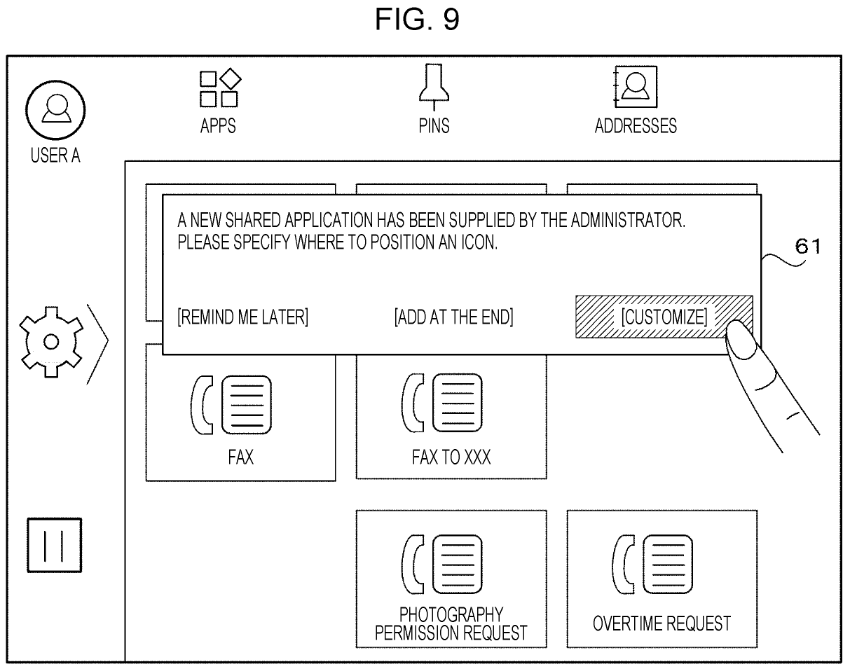

An example of a notification screen displayed as described above is illustrated in FIG. 9. In the example of the notification screen illustrated in FIG. 9, a message window 61 containing characters “A new shared application has been supplied by the administrator. Please specify where to position an icon.” is displayed on the home screen. In the message window 61, options “remind me later,” “add at the end,” and “customize” are displayed.

In step S107, the controller 35 determines whether or not a customization request has been made by the user. In the case where the option “customize” is selected by the user on the notification screen illustrated in FIG. 9, the controller 35 determines that a customization request has been made by the user. In the case where the option “remind me later” is selected by the user on the notification screen illustrated in FIG. 9, the controller 35 determines that a customization request has not been made by the user. Furthermore, in the case where the option “add at the end” is selected by the user on the notification screen illustrated in FIG. 9, the controller 35 positions the operation button to be added at the end of positioned operation buttons.

In the case where it is determined in step S107 that a customization request has not been made by the user, the controller 35 ends the process. In this case, the home screen customized based on the individual layout data is displayed for the user.

In the case where it is determined in step S107 that a customization request has been made by the user, the controller 35 transitions the screen to an operation screen that allows the user to enter the location at which an icon for starting, for example, an added application, is to be positioned in step S108. In step S108, the controller 35 receives the location at which an icon of, for example, the added application, is to be positioned from the user. In step S109, the controller 35 adds the icon to the individual layout data on the basis of the received location. In step S110, the controller 35 displays the home screen based on the individual layout data including the added icon.

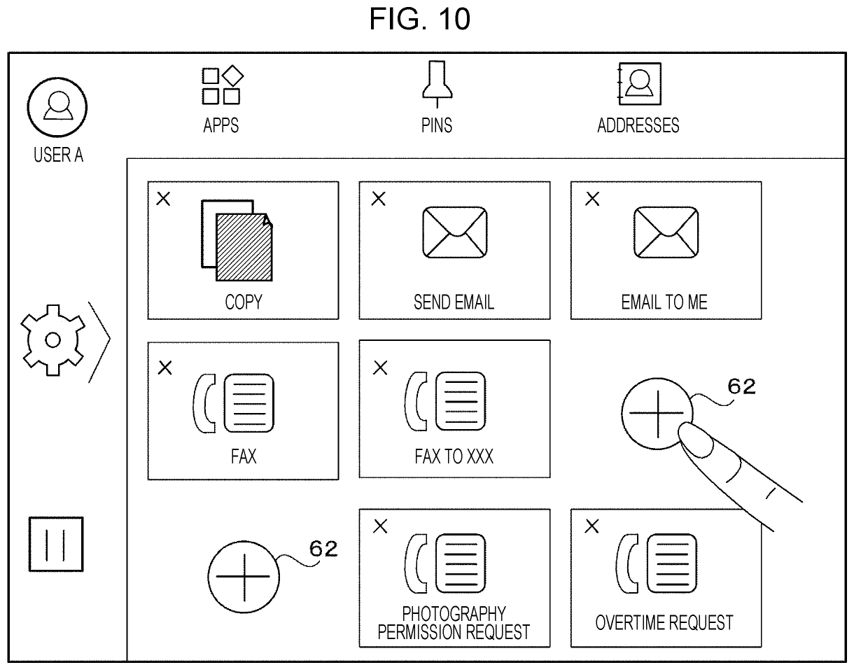

Specifically, the controller 35 displays an operation screen for adding an icon on the operation panel as illustrated in FIG. 10. In the example of the operation screen for adding an icon illustrated in FIG. 10, display operation buttons 62 for displaying an operation button that has not been positioned are displayed. In FIG. 10, in the state in which the normal home screen is transitioned to the customize screen, the display operation buttons 62 are displayed in two regions in which a new operation button is able to be positioned.

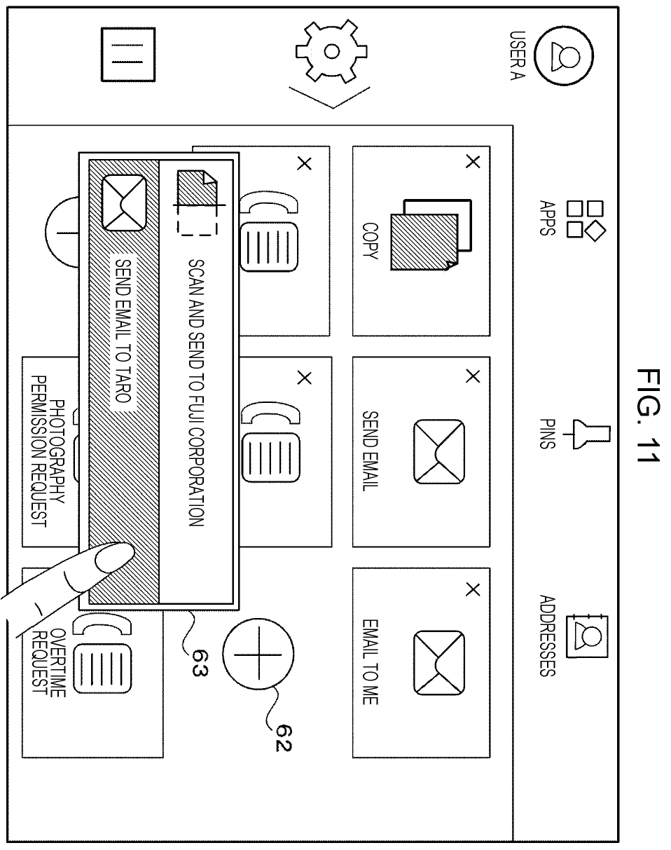

An example of an operation screen displayed when the user operates a display operation button 62 is illustrated in FIG. 11. In the example of the operation screen illustrated in FIG. 11, a popup window 63 is displayed on the customize screen. In the popup window 63, two applications that have not been positioned are displayed.

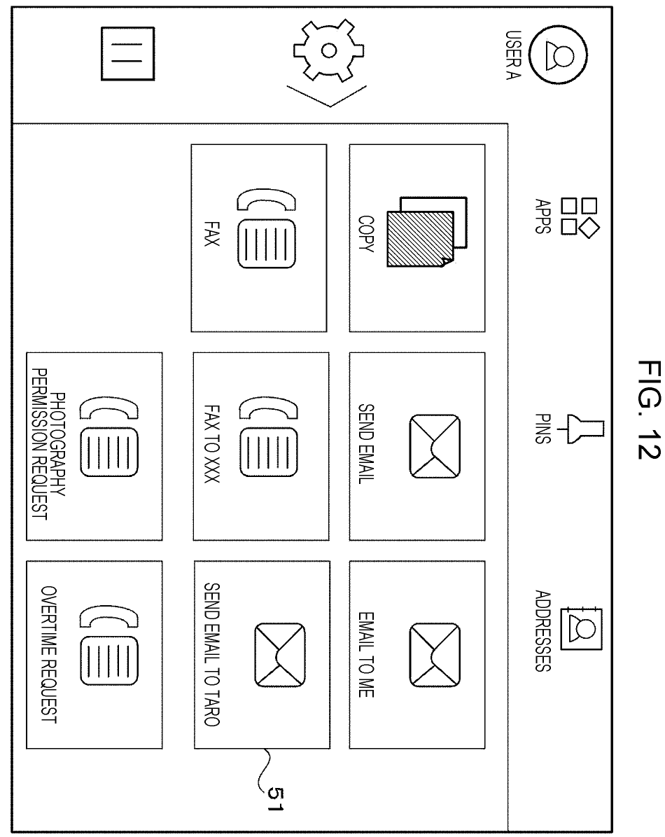

When one of the two applications displayed in the popup window 63 is selected, an icon of the selected application is added on the home screen. An example of a home screen after the icon of the application selected as described above is added on the home screen is illustrated in FIG. 12. In the example of the home screen illustrated in FIG. 12, an icon 51 of the selected application is added.

Next, a modification of the notification screen for notifying the user that there is a new operation button to be positioned on the home screen will be described.

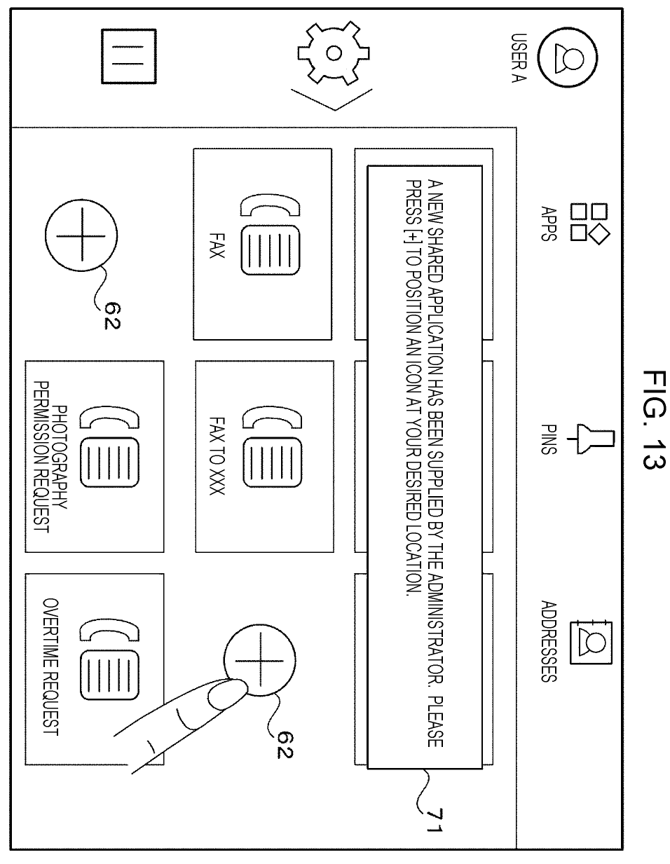

Another example of the notification screen for notifying the user that there is a new operation button to be positioned on the home screen is illustrated in FIG. 13. In the example of the notification screen illustrated in FIG. 13, a message window 71 including characters “A new shared application has been supplied by the administrator. Please press [+] to position an icon at your desired location.” is displayed on the home screen. Furthermore, in FIG. 13, the display operation buttons 62 are displayed in two regions in which a new operation button is able to be positioned. In this notification screen example, when the user presses a display operation button 62, an added new application is popup-displayed even without transition to the customize mode. Then, when an application to be positioned is selected from among applications that are popup-displayed, an operation button for starting the application is positioned. In this notification screen, an option such as “remind me later” is not displayed. By continuing to display the display operation button 62 until arrangement of the operation buttons for all the applications added by the administrator is completed, the user is continuously notified that there is an operation button to be positioned.

With the notification screen described above, an operation button is able to be positioned easily without transition to the customize mode that requires the user to perform a little complicated operation. Furthermore, since the display operation button 62 is continuously displayed until arrangement of the operation buttons corresponding to all the applications added by the administrator is completed, the user is prevented from forgetting to position an operation button.

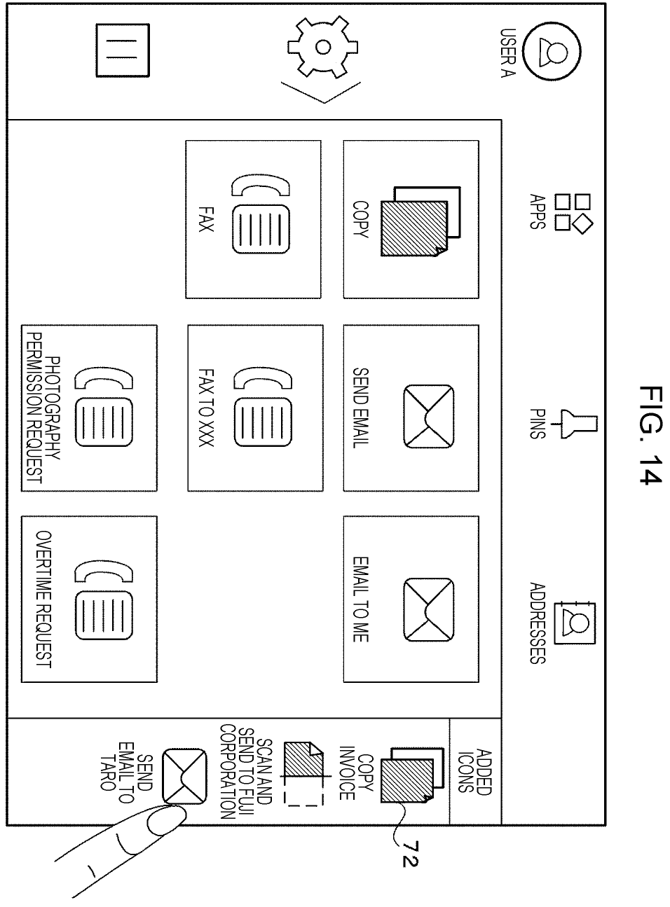

Furthermore, another example of the notification screen for notifying the user that there is a new operation button to be positioned on the home screen is illustrated in FIG. 14. In the example of the notification screen illustrated in FIG. 14, the entire layout is shifted to create a free space so that added operation buttons 72 are positioned in the free space. That is, while the layout of operation buttons customized by the user is maintained, the added operation buttons 72 are positioned in a fixed region that does not affect the layout.

With the notification screen described above, the user is able to recognize that there is an added operation button. Furthermore, by using, for example, a label indicating the name of an added operation button, the added operation button is able to be directly used in a temporary manner. Moreover, by positioning an operation button on the home screen that the user normally uses, the user is able to be prevented from forgetting to position the operation button. Furthermore, since an operation button is positioned in the fixed region, the added operation button is able to be found easily.

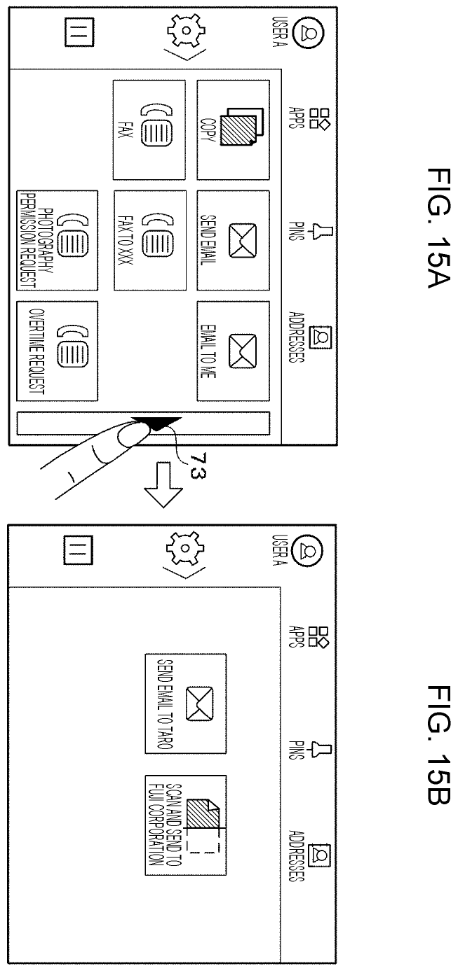

Another example of the notification screen for notifying the user that there is a new operation button to be positioned on the home screen is illustrated in FIGS. 15A and 15B. In the example of the notification screen illustrated in FIG. 15A, a display operation button 73 for displaying an added operation button is positioned on the home screen. When the user operates the display operation button 73, a screen illustrated in FIG. 15B is displayed. On the screen illustrated in FIG. 15B, operation buttons that have not been positioned corresponding to, for example, applications added by the administrator are displayed. By selecting and executing an operation button on this screen, the user is able to use the added application. Furthermore, by transitioning to the customize mode, the user is able to position an added operation button at a desired location on the home screen.

With the notification screen described above, the user is able to recognize that there is an added operation button. Furthermore, by adding a label to an added operation button, the user is able to directly use the added operation button in a temporary manner. On a normal home screen, operation buttons are made to appear by vertical scroll. However, by positioning added operation buttons in a horizontal direction of the home screen, which is different from the vertical scroll, the added operation buttons are able to be positioned in a hidden manner in a place that does not affect the layout of normal operation buttons for the user.

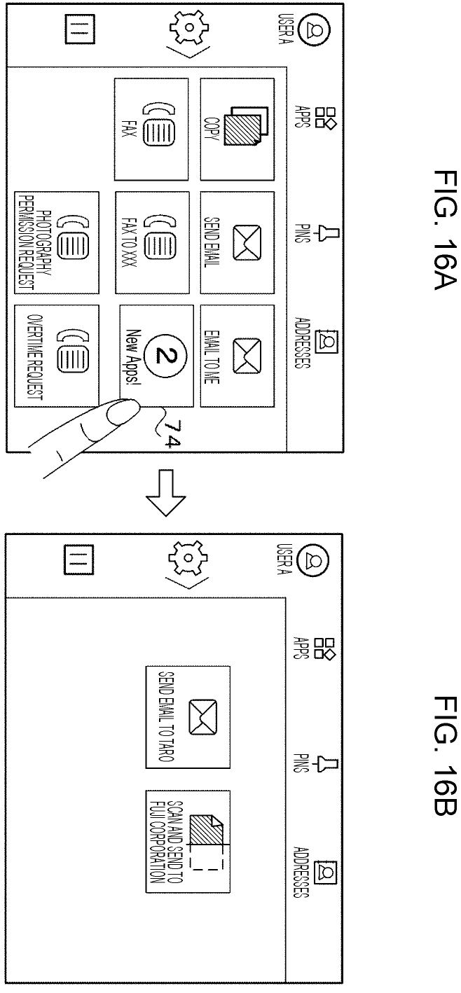

Another example of the notification screen for notifying the user that there is a new operation button to be positioned on the home screen is illustrated in FIGS. 16A and 16B. In the example of the notification screen illustrated in FIG. 16A, a folder containing operation buttons that have not been positioned is added as a folder icon 74 on the home screen. When the user presses the folder icon 74, operation buttons of added applications are popup-displayed, as illustrated in FIG. 16B. Thus, by selecting an operation button of an application that is popup-displayed, the user is able to execute the application.

With the notification screen described above, the user is able to recognize that there is an added operation button. Furthermore, by selecting and pressing the folder icon 74 and then selecting an application from the popup display, the user is able to execute the application immediately. Since a plurality of operation buttons are collectively positioned in a free space on the home screen, the customized layout of the home screen is hardly affected. Furthermore, since operation buttons that have not been positioned are collectively displayed the single folder icon 74, the user is able to find a desired operation button easily.

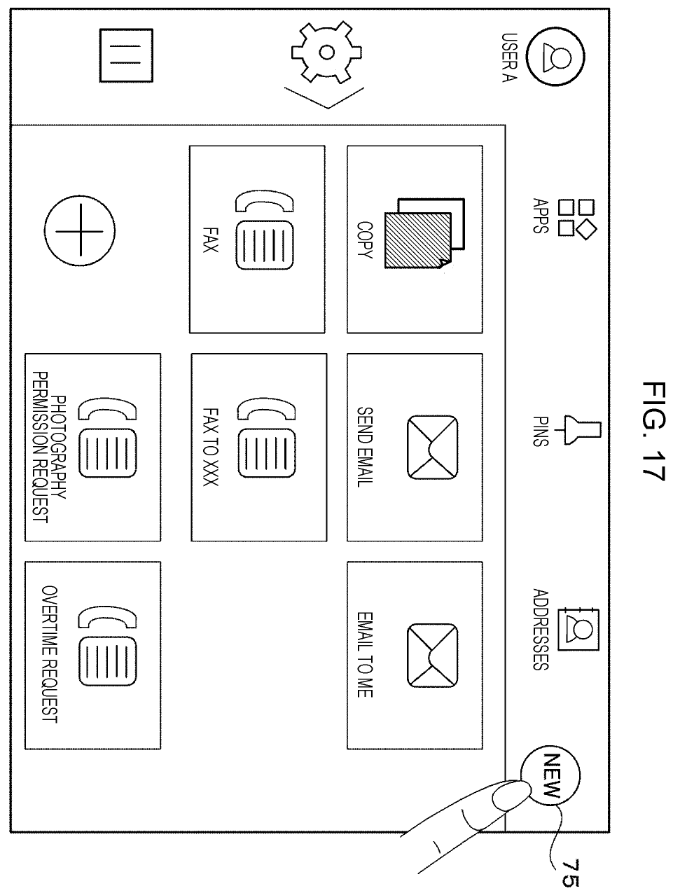

Another example of the notification screen for notifying the user that there is a new operation button to be positioned on the home screen is illustrated in FIG. 17. In the example of the notification screen illustrated in FIG. 17, a notification icon 75 notifies the user that there is an operation button that has not been positioned. When the user presses the notification icon 75, the customize mode is entered so that the user is able to position an added operation button at a desired location.

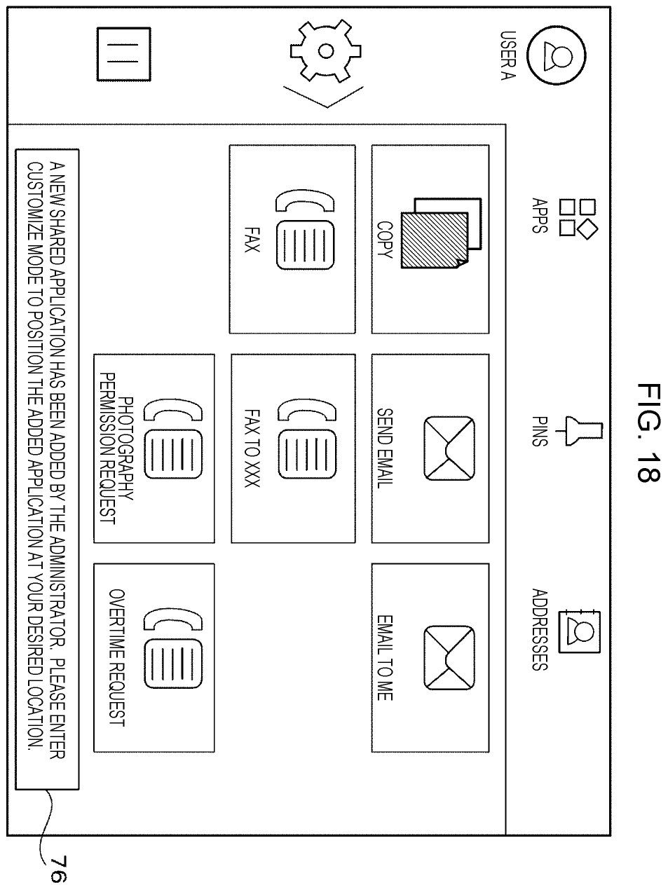

Another example of the notification screen for notifying the user that there is a new operation button to be positioned on the home screen is illustrated in FIG. 18. In the example of the notification screen illustrated in FIG. 18, a message window 76 for notifying the user that there is an operation button that has not been positioned is displayed in a lower part of the home screen. This message window 76 is displayed continuously until all the added operation buttons have been positioned on the home screen by the user. Thus, the message window 76 helps prevent the user from forgetting to position an operation button corresponding to an application added by the administrator.

Processing for setting a notification screen corresponding to the type of an added operation button, setting whether or not to automatically position an operation button without notification to the user, or the like may be performed in advance. For example, an operation button for an added new application or for a service application is set to be automatically positioned at the last page without notification to the user. Furthermore, an operation button for the case where specific quick processing is set for an installed application is set to be notified to the user and to be positioned in accordance with an operation by the user. By setting in advance processing corresponding to the type of an operation button, burden of customization processing on the user is reduced.

In an exemplary embodiment described above, the case where, when the user logs into the image forming apparatus 10, the user is notified that there is a new operation button to be positioned on the operation screen, has been described. However, the present disclosure is not limited to this case. The notification mentioned above is not necessarily provided on the operation screen when the user logs into the image forming apparatus 10 and the notification described above may be provided on a screen displayed later. For example, when the user performs a press and holds operation on the home screen displayed after login and a layout editing mode is entered, the user may be notified that there is a new operation button to be positioned in the layout editing mode. Furthermore, when a display operation button 62, which indicates [+] illustrated in FIG. 10, is pressed on the layout editing mode screen, an application selection list may be displayed. By notifying the user that there is a new application added in the application selection list, the user may be notified that there is a new operation button to be positioned.

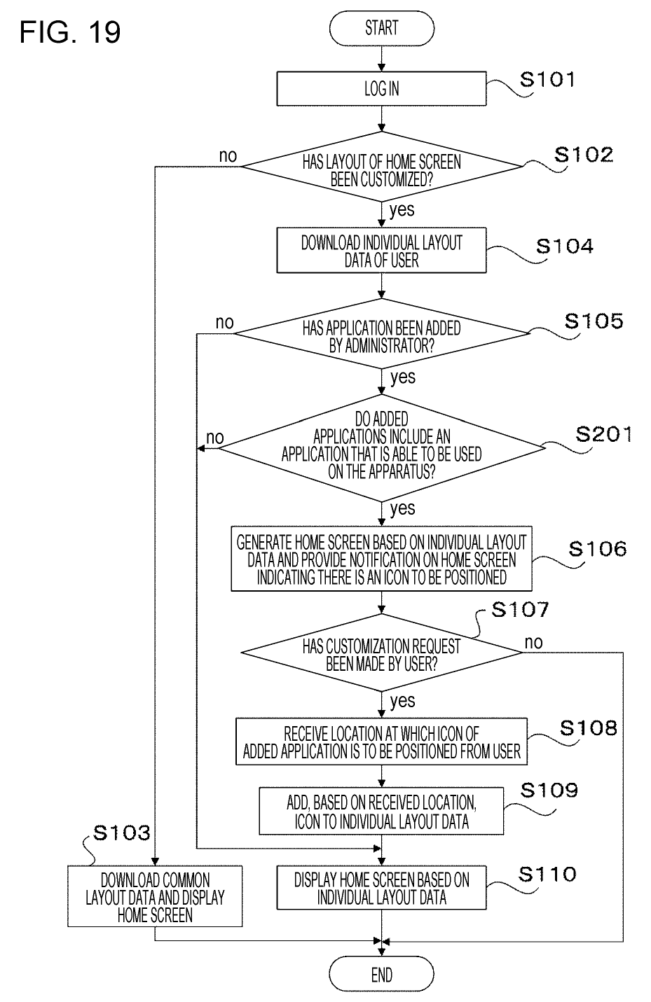

Next, a flowchart of a process for the case where, even when a new operation button to be added on the home screen occurs when or after a user logs into the image forming apparatus 10, if the operation button is not able to be used on the image forming apparatus 10, the user is not notified that there is a new operation button to be positioned on the home screen, is illustrated in FIG. 19.

The flowchart illustrated in FIG. 19 is the same as the flowchart illustrated in FIG. 8 with the exception that processing of step S201 is added. Therefore, only the processing of step S201 will be explained, and description of processing of the other steps will be omitted.

In the case where it is determined in step S105 that, for example, an application, has been added by the administrator, the controller 35 determines in step S201 whether or not, for example, added applications, include an application that is able to be used on the image forming apparatus 10.

In the case where it is determined in step S201 that, for example, added applications, include an application that is able to be used on the image forming apparatus 10, the controller 35 displays the home screen based on the individual layout data on the operation panel and notifies the user that there is a new operation button to be positioned on the home screen in step S106.

In the case where it is determined in step S201 that, for example, added applications, do not include an application that is able to be used on the image forming apparatus 10, the controller 35 displays the home screen based on the downloaded individual layout data on the operation panel in step S110. Also, in the case where, for example, added applications, are, for example, popup-displayed, for the user, the controller 35 displays for the user only an application that is able to be used on the image forming apparatus 10.

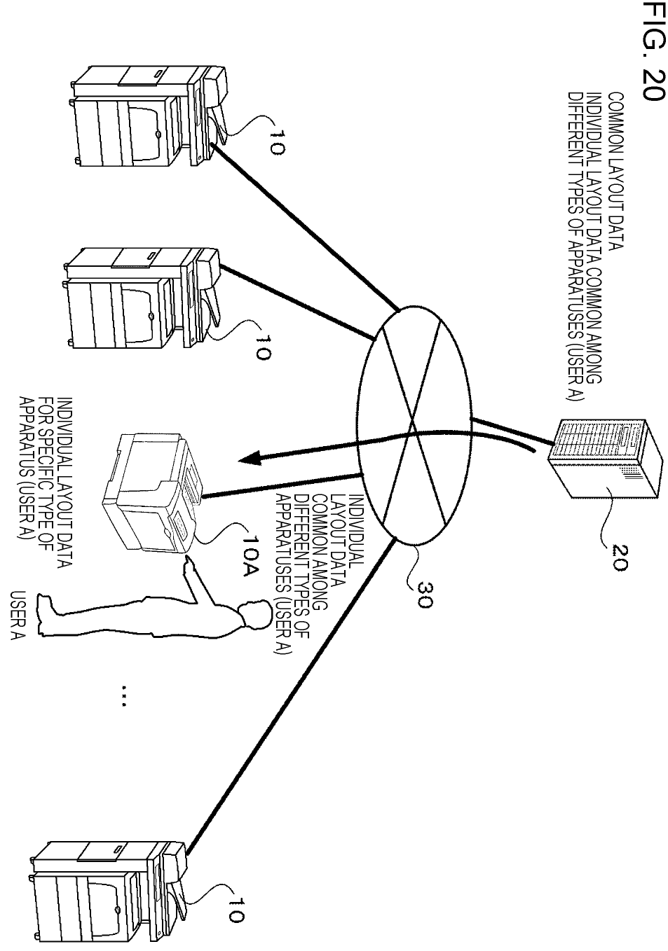

The case where a user has only one piece of individual layout data has been described above. However, a user may set a plurality of pieces of individual layout data for individual types of apparatuses. For example, as illustrated in FIG. 20, the user A may set a piece of individual layout data that is common among a plurality of image forming apparatuses 10 and set a piece of individual layout data for a specific type of apparatus corresponding to a specific image forming apparatus 10A. In this case, the individual layout data for the specific type of apparatus is set in advance in the image forming apparatus 10A, and the individual layout data that is common among different types of apparatuses is downloaded from the management server 20.

In this case, when an operation button added by the administrator is added at a location in the individual layout data that is common among different types of apparatuses, another operation button may have already been positioned at the location in the individual layout data for the specific type of apparatus. In the case where there is a conflict in the location at which an operation button is to be positioned among a plurality of pieces individual layout data, the operation button is kept on hold without being automatically positioned in the individual layout data for the specific type of apparatus. When or after the user A logs into the image forming apparatus 10A, the user A is notified by the notification screen described above that there is a new operation button to be positioned.

The term “system” in an exemplary embodiment includes a system including a plurality of apparatuses and a system including a single apparatus.

The present disclosure is applicable to a program and a program product.

### Modifications

In an exemplary embodiment described above, the case where a home screen is displayed on an operation panel of each of a plurality of image forming apparatuses has been described. However, the present disclosure is not limited to this case. The present disclosure is also applicable in a similar manner to a case where operators such as operation buttons are positioned on an operation screen of an information processing apparatus that is different from an image forming apparatus and customization is able to be performed for each user. For example, the present disclosure is also applicable to a case where operation buttons positioned on an operation panel of a vehicle are able to be customized for each member of a family.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(1) An information processing system comprising:

a processor configured to:

in a case where an operation screen of a user has been changed from a default setting state and a new operator to be added on the operation screen occurs, when or after the user logs in, notify the user that there is a new operator to be positioned on the operation screen; and

position the new operator in a region of the operation screen selected by the user.

(2) The information processing system according to (1), wherein the new operator to be added on the operation screen is an operator that has been made to be added as a result of an operation by a different user.

(3) The information processing system according to (2), wherein the different user is an administrative user, and the new operator to be added on the operation screen is an operator added by the administrative user or an operator for operating an application program installed by the administrative user.

(4) The information processing system according to any one of (1) to (3), wherein the processor is configured to:

in the case where the operation screen of the user has been changed from the default setting state and the new operator to be added on the operation screen occurs, when or after the user logs in, display on the operation screen a display operator for notifying that there is a new operator to be positioned on the operation screen and displaying an operator that has not been positioned; and

in response to an operation on the display operator by the user, display the operator that has not been positioned.

(5) The information processing system according to (4), wherein the processor is configured to display the display operator in a region of the operation screen in which a new operator is able to be positioned.

(6) The information processing system according to (4), wherein the processor is configured to, in a state in which a change mode screen for changing a layout of operators is entered, display the display operator on the operation screen.

(7) The information processing system according to any one of (1) to (6), wherein the processor is configured to, until all new operators to be added have been positioned on the operation screen, continuously notify that there is a new operator to be positioned on the operation screen.

(8) An information processing system comprising:

a memory that stores a condition for a new operator that requires notification when the operator is added; and

a processor configured to:

in a case where an operation screen of a user has been changed from a default setting state and a new operator to be added on the operation screen occurs, provided that the operator satisfies the condition, when or after the user logs in, notify the user that there is a new operator to be positioned on the operation screen;

position the new operator in a region of the operation screen selected by the user; and

even in the case where a new operator to be added on the operation screen occurs, if the operator does not satisfy the condition, when or after the user logs in, not notify the user that there is a new operator to be positioned on the operation screen.

(9) A program causing a computer to execute a process comprising:

in a case where an operation screen of a user has been changed from a default setting state and a new operator to be added on the operation screen occurs, when or after the user logs in, notifying the user that there is a new operator to be positioned on the operation screen; and

positioning the new operator in a region of the operation screen selected by the user.

What is claimed is:

1. An information processing system comprising:
a processor configured to:
in a case where an operation screen of a user has been changed from a default setting state and a new operator to be added on the operation screen occurs, when or after the user logs in, notify the user that there is a new operator to be positioned on the operation screen; and
position the new operator in a region of the operation screen selected by the user.

2. The information processing system according to claim 1, wherein the new operator to be added on the operation screen is an operator that has been made to be added as a result of an operation by a different user.

3. The information processing system according to claim 2, wherein the different user is an administrative user, and the new operator to be added on the operation screen is an operator added by the administrative user or an operator for operating an application program installed by the administrative user.

4. The information processing system according to claim 1, wherein the processor is configured to:
in the case where the operation screen of the user has been changed from the default setting state and the new operator to be added on the operation screen occurs, when or after the user logs in, display on the operation screen a display operator for notifying that there is a new operator to be positioned on the operation screen and displaying an operator that has not been positioned; and
in response to an operation on the display operator by the user, display the operator that has not been positioned.

5. The information processing system according to claim 4, wherein the processor is configured to display the display operator in a region of the operation screen in which a new operator is able to be positioned.

6. The information processing system according to claim 4, wherein the processor is configured to, in a state in which a change mode screen for changing a layout of operators is entered, display the display operator on the operation screen.

7. The information processing system according to claim 1, wherein the processor is configured to, until all new operators to be added have been positioned on the operation screen, continuously notify that there is a new operator to be positioned on the operation screen.

8. An information processing system comprising:
a memory that stores a condition for a new operator that requires notification when the operator is added; and
a processor configured to:
in a case where an operation screen of a user has been changed from a default setting state and a new operator to be added on the operation screen occurs, provided that the operator satisfies the condition, when or after the user logs in, notify the user that there is a new operator to be positioned on the operation screen;
position the new operator in a region of the operation screen selected by the user; and
even in the case where a new operator to be added on the operation screen occurs, if the operator does not satisfy the condition, when or after the user logs in, not notify the user that there is a new operator to be positioned on the operation screen.

9. A non-transitory computer readable medium storing a program causing a computer to execute a process comprising:
in a case where an operation screen of a user has been changed from a default setting state and a new operator to be added on the operation screen occurs, when or after the user logs in, notifying the user that there is a new operator to be positioned on the operation screen; and
positioning the new operator in a region of the operation screen selected by the user.
